(19) United States
(12) Patent Application Publication
(10) Pub. No.: US 2025/0244291 A1
(43) Pub. Date: Jul. 31, 2025

(54) EDDY-CURRENT FLAW DETECTION DEVICE AND EDDY-CURRENT FLAW DETECTION METHOD

(71) Applicant: IHI Corporation, Tokyo (JP)

(72) Inventors: Atsuko NUMA, Tokyo (JP); Koichi INAGAKI, Tokyo (JP)

(73) Assignee: IHI Corporation, Tokyo (JP)

(21) Appl. No.: 19/087,759

(22) Filed: Mar. 24, 2025

Related U.S. Application Data
(63) Continuation of application No. PCT/JP2023/034625, filed on Sep. 25, 2023.

(30) Foreign Application Priority Data
Jan. 13, 2023 (JP) 2023-003840

(51) Int. Cl. G01N 27/9013

(52) U.S. Cl. CPC G01N 27/902

(57) ABSTRACT

An eddy-current flaw detection device includes: a probe for detecting a change in eddy-current in a component surface of an inspection object; and a control unit for causing the probe to scan the component surface along a scanning path that crosses an edge of the component surface. The scanning path includes a first scanning path that is scanned in a first direction from a first region of the component surface adjacent to an edge region extending along the edge to a region outside the edge across the edge region. The probe scans along the first scanning path to detect the change in eddy-current in the edge region.

### CROSS-REFERENCE TO RELATED APPLICATIONS

The present application is a continuation application of International Application No. PCT/JP2023/034625, now WO 2024/150473 A1, filed on Sep. 25, 2023, which claims priority to Japanese Patent Application No. 2023-003840, filed on Jan. 13, 2023, the entire contents of which are incorporated by reference herein.

### BACKGROUND OF THE INVENTION

### Technical Field

The present disclosure relates to an eddy-current flaw detection device and eddy-current flaw detection method.

### Background

The eddy-current inspection system disclosed in JP 5122807 B includes an eddy-current probe and a computer connected to the eddy-current probe. The computer generates an original image of a component under test, decomposes the original image into images each of which has a different spatial frequency component, and stores spatial frequency data including a spatial frequency component corresponding to a known eddy-current flaw signal. The computer selects images from among images containing different spatial frequency components corresponding to a known eddy-current flaw signal which is based on the stored spatial frequency data. The computer is also configured to reconstruct at least one final image of the component using the selected images.

### SUMMARY OF INVENTION

By the way, an eddy-current flaw detection test has been performed to detect scratches on a surface of a metal component, for example. In the eddy-current flaw detection test, a probe is scanned on a surface of a component to be inspected, and changes in eddy-current generated on the surface are detected. Thus, scratches on the component surface can be detected. Here, it is known to cause an edge effect in which the eddy-current generated on the component surface changes and an edge signal is detected when the magnetic field generated from the coil of the probe crosses the edge of the component to be inspected. In addition, there were cases where a defect signal indicating a defect such as a crack in the vicinity of the edge was hidden in the edge signal, thereby making it difficult to detect the defect. For this reason, there have been cases where the eddy-current flaw detection test has been performed in separate inspection steps for the surface of the component adjacent to the edges and the surface other than the surface adjacent to the edges. In other words, the eddy-current flaw detection test may become complicated due to the edge effect.

An eddy-current flaw detection device according to the present disclosure includes: a probe configured to detect a change in eddy-current in a component surface of an inspection object; and a control unit configured to cause the probe to scan the component surface along a scanning path that crosses an edge of the component surface; wherein the scanning path includes a first scanning path that is scanned in a first direction from a first region of the component surface adjacent to an edge region extending along the edge to a region outside the edge across the edge region, and the probe scans along the first scanning path to detect the change in eddy-current in the edge region.

In the eddy-current flaw detection device described above, the scanning path may include a second scanning path that is scanned in a second direction from the region outside the edge to the first region across the edge, and the probe may scan along the second scanning path to detect the change in eddy-current in the first region.

The eddy-current flaw detection device described above may further include: a determination unit configured to determine a first region signal indicating the change in eddy-current in the first region, wherein the first region signal may include: a first signal detected by scanning along the first scanning path and a second signal detected by scanning along the second scanning path, and the determination unit may determine one of the first signal and the second signal, which has a higher intensity, as the first region signal.

An eddy-current flaw detection method according to the present disclosure includes: scanning a component surface of an inspection object by a probe that detects a change in eddy-current in the component surface along a scanning path that crosses an edge of the component surface; wherein the scanning path includes a first scanning path that is scanned in the first direction from the first region of the component surface adjacent to the edge region extending along the edge toward the region outside the edge across the edge region; and the probe scans along the first scanning path to detect the change of eddy-current in the edge region.

According to the present disclosure, it is possible to provide an eddy-current flaw detection device and an eddy-current flaw detection method capable of more easily performing an eddy-current flaw detection test.

### BRIEF DESCRIPTION OF DRAWINGS

FIG. 1 is a schematic perspective view showing an example of the overall configuration of an eddy-current flaw detection device according to an embodiment.

FIG. 2 is a schematic perspective view showing an inspection object of the eddy-current flaw detection device according to an embodiment.

FIG. 3 is a block view showing an example of the overall configuration of an eddy-current flaw detection device according to an embodiment.

FIG. 4 is a schematic view showing a probe of an eddy-current flaw detection device according to an embodiment.

FIG. 5 is a view for explaining an inspection process performed by an eddy-current flaw detection device according to an embodiment, and is a schematic perspective view showing a positional relationship between a probe and a surface to be inspected by an eddy-current flaw detection test.

FIG. 6 is a view for explaining a first process of an edge inspection process performed by an eddy-current flaw detection device according to an embodiment, and is a schematic side view showing a positional relationship between the probe and the surface to be inspected by an eddy-current flaw detection test.

FIG. 7 is a view for explaining a second process of the edge inspection process performed by the eddy-current flaw detection device according to an embodiment, and is a schematic side view showing a positional relationship between the probe and the surface to be inspected by an eddy-current flaw detection test.

FIG. 8 is a view for explaining a third process of an edge inspection process performed by the eddy-current flaw detection device according to an embodiment, and is a schematic side view showing a positional relationship between the probe and the surface to be inspected by the eddy-current flaw detection test.

### DESCRIPTION OF EMBODIMENTS

Hereinafter, some exemplary embodiments will be described with reference to the drawings. Elements having the same function are denoted by the same reference numerals, and duplicate descriptions are omitted.

A X-axis direction in each figure is the direction in which a first slider 4a, which will be described later, can move, and the positive X-axis direction and the negative X-axis direction are referred to simply as the “X-axis direction”. A Y-axis direction is the direction in which a second slider 4b, which will be described later, can move, and the positive Y-axis direction and the negative Y-axis direction are referred to simply as the “Y-axis direction”. A Z-axis direction is the direction in which a third slider 4c, which will be described later, can move, and the positive Z-axis direction and the negative Z-axis direction are referred to simply as the “Z-axis direction”. The positive Z-axis direction corresponds to the upward direction, and the negative Z-axis direction corresponds to the downward direction. The X-axis direction, the Y-axis direction, and the Z-axis direction cross each other, and may be substantially orthogonal to each other, for example. A θ-axis direction is the direction of rotation around an axis A1, which will be described later, and the positive e-axis direction and the negative θ-axis direction are referred to simply as the “θ-axis direction”. A P-axis direction is the direction of rotation about the extending direction of a probe shaft 7, which will be described later, and the positive P-axis direction and the negative P-axis direction are referred to simply as the “P-axis direction”. An R-axis direction is the direction of rotation around an axis A2 of a stage 6, which will be described later, and the positive R-axis direction and the negative R-axis direction are referred to simply as the “R-axis direction”.

The eddy-current flaw detection device and eddy-current flaw detection method according to the embodiment can be used for eddy-current flaw detection test. In the eddy-current flaw detection test, the presence or absence of defects, such as cracks, which exist in an electrically conductive inspection object can be inspected. The eddy-current flaw detection test is also called ET (Eddy-current testing).

In the eddy-current flaw detection test, an eddy-current is generated on a surface of the inspection object by forming a magnetic field on the surface of the inspection object with an excitation coil. Then, the magnetic field induced by the eddy-current is detected by a detection coil. When a defect exists on the surface of the inspection object, the flow path of the eddy-current changes due to the effect of the defect. As a result, the magnetic field induced by the eddy-current changes. By detecting such a change in the magnetic field by the detection coil, it is possible to determine whether a defect exists on the surface of the inspection object. That is, the state of the surface of the inspection object can be inspected by detecting a change in eddy-current caused by the presence or absence of defects.

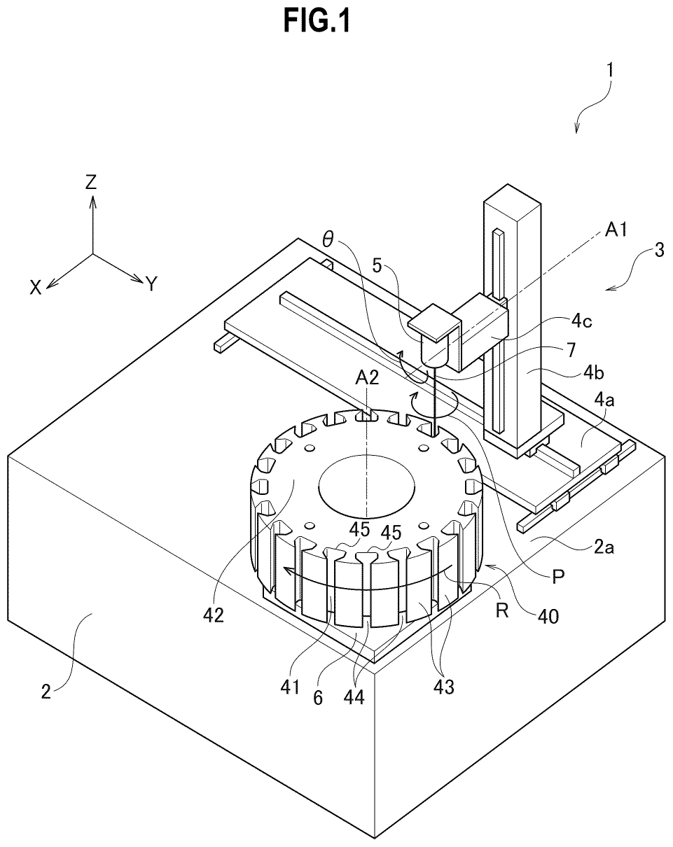

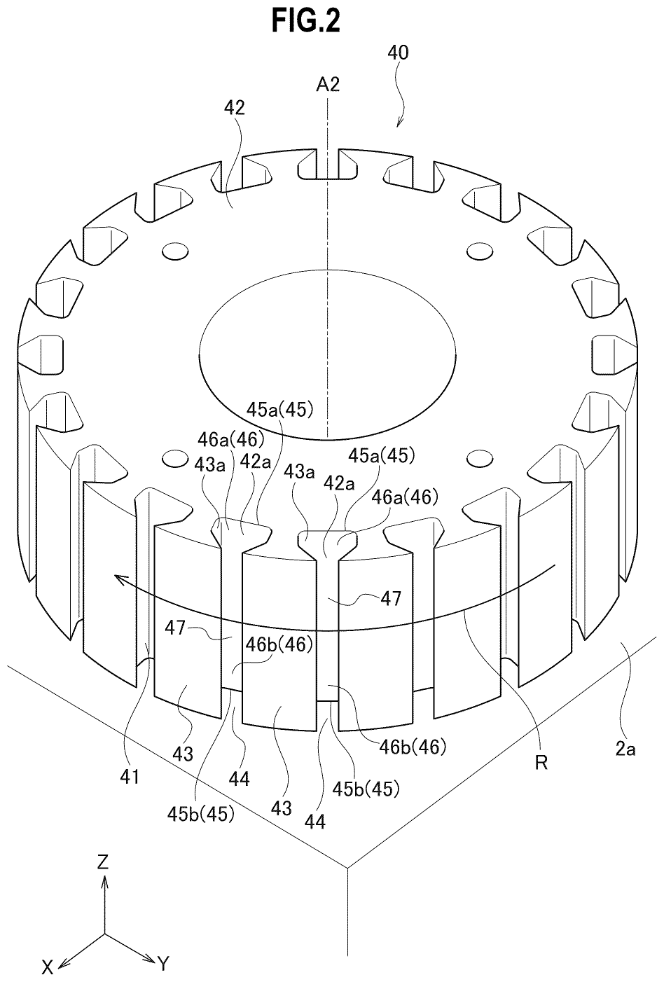

First, examples of the inspection device 1 and the inspection object will be described with reference to FIGS. 1 and 2. The inspection device 1 is an eddy-current flaw detection device for inspecting a component surface 41. The component surface 41 is a surface of a component 40 as the inspection object and is a surface to be subjected to the eddy-current flaw detection test. The component surface 41 may be a part of the entire surface of the component 40. The inspection device 1 performs an eddy-current flaw detection test to determine whether or not a defect exists on the component surface 41. The structure of the inspection device 1 is not limited to the structure illustrated in the figure, and the structure may be appropriately changed according to the shape, size, installation location of the inspection device 1, type of the component 40, etc.

As illustrated in FIG. 1, the inspection device 1 includes a frame 2 and a drive mechanism 3. The frame 2 is constituted by combining, for example, metal columns and beams. An upper surface 2a is formed on the upper portion of the frame 2. A component 40 (see FIG. 2) can be placed on the upper surface 2a. The upper surface 2a may extend substantially parallel to the XY plane.

The component 40 illustrated in FIGS. 1 and 2 has a substantially cylindrical shape as a whole. The component 40 is made of, for example, metal. When the component 40 is placed on the upper surface 2a, the central axis of the cylindrical shape may extend substantially parallel to the Z-axis direction. The component 40 has, for example, a body 42, projections 43, and slots 44.

The body 42 constitutes a part of the component 40 from the inner peripheral side of the component 40 to the outer peripheral side of the component 40. The projections 43 are arranged on the outer peripheral side of the body 42. That is, projections 43 and slots 44 are formed on the outer peripheral part of the component 40. The projections 43 are formed to extend outward in the radial direction of the component 40 from the body 42, and may extend vertically when the component 40 is placed on the upper surface 2a. Each of the projections 43 may be located on the circumference of the same circle around the axis A2 in plan view, and each of the projections 43 may be formed to be spaced at a predetermined interval in the R-axis direction. Slots 44 are formed between two of the projections 43 adjacent to each other. The slots 44 are groove portions extending vertically when the component 40 is placed on the upper surface 2a. Slots 44 may be formed at a predetermined interval in the R-axis direction on the outer periphery of the component 40. The shape, size or posture of the component 40 are not limited to the example shown in the figure.

The slot 44 is defined by an outer peripheral surface 42a of the body 42 and side surfaces 43a of the projections 43. The outer peripheral surface 42a forms a part of the outer peripheral portion of the body 42. The side surface 43a forms a part of the projection 43 in the R-axis direction.

The drive mechanism 3 is a mechanism for controlling the position or posture of the probe 10 or component 40, which will be described later. The drive mechanism 3 may be disposed at a predetermined position on the upper surface 2a. The drive mechanism 3 may have, for example, at least one of a first slider 4a, a second slider 4b, a third slider 4c, a holding member 5, and a stage 6.

The first slider 4a is a member movable in the X-axis direction in an area above the upper surface 2a. The first slider 4a may be a long metal member extending in the Y-axis direction. The first slider 4a may be movable in the X-axis direction by sliding along a rail extending in the X-axis direction disposed on the upper surface 2a, for example.

The second slider 4b is a member movable in the Y-axis direction in an area above the upper surface 2a. The second slider 4b may be a long metal member extending in the Z-axis direction. The second slider 4b may be movable in the Y-axis direction on the first slider 4a by sliding along a rail extending in the Y-axis direction disposed on the upper surface of the first slider 4a, for example.

The third slider 4c is a member movable in the Z-axis direction in an area above the upper surface 2a. The third slider 4c may be a member extending in the X-axis direction. The third slider 4c may be movable in the Z-axis direction by sliding along a rail extending in the Z-axis direction disposed on the second slider 4b, for example. The third slider 4c is attached to the second slider 4b to project in the X-axis positive direction from the X-axis positive side surface of the second slider 4b. A holding member 5 may be fixed to the end of the third slider 4c on the positive X-axis side.

The holding member 5 holds an end of the probe shaft 7, and in the state illustrated in FIG. 1, the probe shaft 7 extends from the holding member 5 in the negative Z-axis direction. A probe 10 (see FIG. 4) is attached to a tip of the probe shaft 7 on the negative Z-axis side. That is, the probe shaft 7 is a member connecting the holding member 5 and the probe 10. The holding member 5 may rotatably hold the probe shaft 7 around its extending direction. Thus, the holding member 5 can rotate the probe 10 in the P-axis direction. The holding member 5 may be fixed to the third slider 4c to be rotatable around the axis A1. Thus, it is possible to rotate the holding member 5 in the θ-axis direction around the axis A1 as the center axis. The axis A1 is an axis extending in the X-axis direction.

The stage 6 is a member capable of supporting the component 40 and is disposed in a predetermined region of the upper surface 2a. The stage 6 may be rotatable around the axis A2. That is, the stage 6 may rotatably support the component 40 about around axis A2. The axis A2 illustrated in FIG. 1 is an axis extending in the Z-axis direction, but is not limited thereto. For example, the axis A2 may be inclined with respect to the Z-axis.

With such a drive mechanism 3, for example, by adjusting the positions of the first slider 4a, the second slider 4b, and the third slider 4c, the positions of the probe 10 in the X-axis direction, the Y-axis direction, and the Z-axis direction can be adjusted. Also, by adjusting the rotation of the probe shaft 7 in the P-axis direction, the orientation of the coil 11 described later in the probe 10 can be adjusted. That is, the P-axis direction corresponds to the rotation direction around the rotation center axis of the probe 10. The angle of the probe 10 with respect to the Z-axis direction can be adjusted by adjusting the rotation of the holding member 5 in the e-axis direction. The position of each part of the component 40 in the R-axis direction can be adjusted by adjusting the rotation around the axis A2 of the stage 6 while the component 40 is fixed to the stage 6. That is, the position or posture of the probe 10 or each part of the component 40 can be set to an arbitrary state by the drive mechanism 3. Thus, the eddy-current flaw detection test can be performed more accurately in accordance with the shape of the component 40.

The structure of the drive mechanism 3 is not limited to the illustrated example. The structure of the drive mechanism 3 can be appropriately changed according to the shape, dimensions, installation location of the inspection device 1, the type of the component 40, etc. The drive mechanism 3 can be adjusted in the X-axis direction, the Y-axis direction, the Z-axis direction, the P-axis direction, the e-axis direction, and the R-axis direction, but is not limited thereto. The number of axes that can be adjusted by the drive mechanism 3 can be appropriately changed according to the shape, dimensions, installation location of the inspection device 1, the type of the component 40, etc.

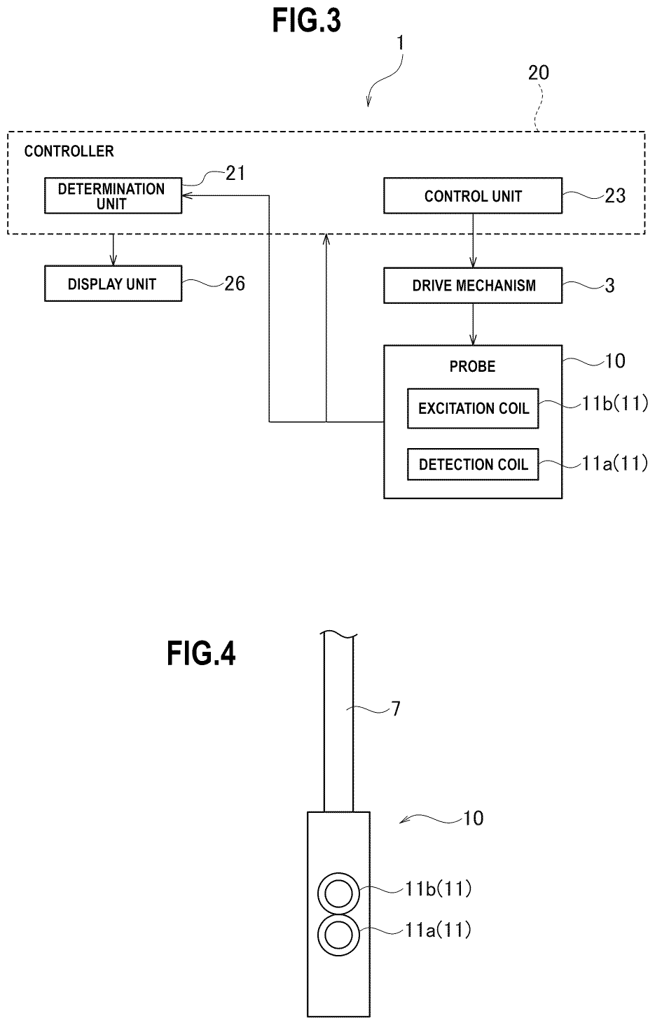

Next, an example of the configuration of the inspection device 1 will be described with reference to FIGS. 3 and 4. The inspection device 1 illustrated in FIG. 3 includes a probe 10 and a control unit 23. The control unit 23 constitutes a part of the controller 20 described later. The controller 20 may also include a determination unit 21.

First, the probe 10 will be described. The probe 10 is a module that scans the surface of the inspection object along a predetermined scanning path and detects a change in eddy-current on the surface in the scanning path. The probe 10 is connected to the drive mechanism 3 via the probe shaft 7. The probe 10 illustrated in the figure detects the change in eddy-current in the component surface 41 of the component 40.

As illustrated in FIG. 4, the probe 10 has a substantially cylindrical shape extending in a direction parallel to the extending direction of the probe shaft 7. A coil 11 is disposed on the side portion of the probe 10. The coil 11 may include an excitation coil 11a and a detection coil 11b. The excitation coil 11a is a coil for generating eddy-current on the surface of the inspection object. The detection coil 11b is a coil for detecting the magnetic field induced by the eddy-current.

In the eddy-current flaw detection test, the probe 10 scans a predetermined scanning path. At this time, eddy-current is generated on the surface of the inspection object by the excitation coil 11a through which AC current flows. When a defect such as a crack exists in the inspection object, the eddy-current changes due to the effect of the defect. Therefore, the magnetic field induced by the eddy-current changes. This change in the magnetic field is detected by the detection coil 11b, and a signal indicating the change in eddy-current can be obtained.

In the example shown in FIG. 4, the excitation coil 11a and the detection coil 11b are directly adjacent to each other in the extending direction of the probe 10, and the detection coil 11b is disposed on the probe shaft 7 side of the excitation coil 11a. However, the position of the excitation coil 11a or the detection coil 11b in the probe 10 is not limited to the position shown in FIG. 4, and may be appropriately changed according to the shape of the inspection object, for example.

Next, the controller 20 will be described. The controller 20 illustrated in FIG. 3 includes a control unit 23. The controller 20 is a unit that performs processes necessary for the eddy-current flaw detection test. For example, the controller 20 may be a general-purpose microcomputer that includes a central processing unit (CPU), a memory, an input/output unit, and the like. In the memory of the microcomputer, a computer program including predetermined rules and instructions for processes of the eddy-current flaw detection test is installed. By executing the computer program, the microcomputer can perform the eddy-current flaw detection test. The controller 20 may be disposed, for example, in the inspection device 1.

The controller 20 controls the position or posture of the probe 10 when performing the eddy-current flaw detection test in the inspection device 1. The controller 20 may also acquire a signal indicating the change in eddy-current detected by the probe 10 and output information related to the signal to the display unit 26 described later.

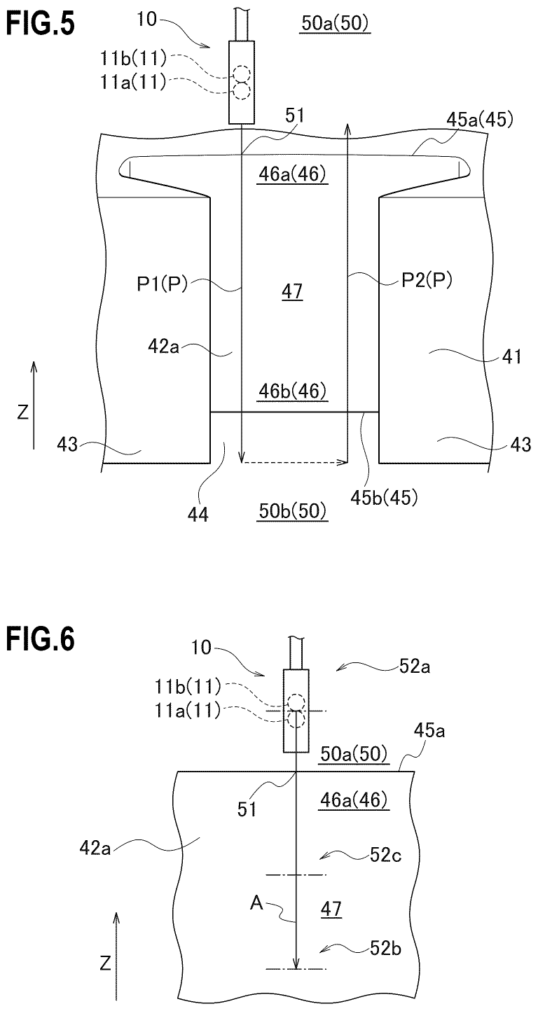

The control unit 23 can control the position or posture of the probe 10 or the component 40. A drive mechanism 3 is connected to the control unit 23. The drive mechanism 3 sets the position or posture of the probe 10 or the component 40 based on a command output from the control unit 23. For example, the control unit 23 outputs various control values to the drive mechanism 3. The control value output to the drive mechanism 3 is, for example, a value (signal) for controlling the position, posture, or rotation of the first slider 4a, the second slider 4b, the third slider 4c, the holding member 5, or the stage 6. In the eddy-current flaw detection test using the inspection device 1, the control unit 23 controls the movement of the probe 10 to scan the component surface 41 along the scanning path P (see FIG. 5). The scanning path P is a path that crosses the edge 45 of the component surface 41.

The controller 20 may include a determination unit 21. The determination unit 21 determines a first region signal indicating the change in eddy-current in the first region 47. In the edge inspection process described later, a first signal and a second signal described later associated with the same sections of the first region 47 may be obtained. In such a case, the determination unit 21 may determine the first region signal from the first signal and the second signal. The determination unit 21 may determine one of the first and second signals, which has a higher intensity, as the first region signal.

A display unit 26 may be connected to the controller 20. The display unit 26 may be, for example, a liquid crystal display or a touch panel display. The display unit 26 illustrated in FIG. 3 displays information related to a signal obtained by the eddy-current flaw detection test output from the controller 20. The information displayed on the display unit 26 is not particularly limited, and may display any information such as measurement conditions for conducting the eddy-current flaw detection test, information related to the component 40, and others.

Next, an operation example of the inspection device 1 will be described with reference to FIGS. 5 to 8. In the eddy-current flaw detection test illustrated in FIG. 5, the probe 10 scans the component surface 41 along the scanning path P, thereby detecting a signal indicating the change in eddy-current, and inspects whether or not a defect exists on the component surface 41. In the following description, an inspection process using the inspection device 1 will be described by referring to the case where the eddy-current flaw detection test is conducted on the outer peripheral surface 42a of the component surface 41. In this inspection process, an edge inspection process described later is performed. Note that the component surface 41 on which the eddy-current flaw detection test is conducted is not limited to the outer peripheral surface 42a, and the eddy-current flaw detection test may be conducted on other surfaces of the component surface 41.

### [Inspection Process]

In the inspection process, the control unit 23 performs an eddy-current flaw detection test on the outer peripheral surface 42a while controlling the position or posture of the probe 10. That is, in the inspection process, the control unit 23 controls the movement of the probe 10 to scan the outer peripheral surface 42a along the scanning path P. Then, the probe 10 detects a change in eddy-current on the outer peripheral surface 42a. The outer peripheral surface 42a illustrated in FIG. 5 has an edge 45, an edge region 46, and a first region 47.

The edge 45 is an edge constituting both ends of the outer peripheral surface 42a in the scanning direction of the probe 10. The edge 45 may include an edge 45a constituting an end on the positive Z-axis direction side of the outer peripheral surface 42a and an edge 45b constituting an end on the negative Z-axis direction side.

The edge region 46 is a region extending along the edge 45 of the outer peripheral surface 42a. The edge region 46 may include an edge region 46a and an edge region 46b. The edge region 46a extends along the edge 45a in a predetermined range on the negative Z-axis direction side of the edge 45a. The edge region 46b extends along the edge 45b in a predetermined range on the positive Z-axis direction side of the edge 45b. The dimensions of the edge regions 46a and 46b in the Z-axis direction are, for example, 1 mm to 5 mm.

The first region 47 is a region directly adjacent to the edge region 46 in the outer peripheral surface 42a. The first region 47 illustrated in the figure extends between the edge region 46a and the edge region 46b.

A region 50 is formed outside the edge 45 in the Z-axis direction. The region 50 may include a region 50a located on the positive Z-axis side of the edge 45a and a region 50b located on the negative Z-axis side of the edge 45b. The region 50a is a space located above the outer peripheral surface 42a and is located outside the edge 45a in the Z-axis direction. The region 50b is a space located below the outer peripheral surface 42a and is located outside the edge 45b in the Z-axis direction.

The scanning path P illustrated in FIG. 5 is a path set when the outer peripheral surface 42a is scanned. The probe 10 scans the outer peripheral surface 42a along the scanning path P. The scanning path P may include multiple paths. For example, the scanning path P includes a path P1 and a path P2.

Each of the paths P1 and P2 is a scanning path set on the outer peripheral surface 42a. These extend in the Z-axis direction, for example. The overall scanning direction of the probe 10 may be the negative Z-axis direction in the path P1 and the positive Z-axis direction in the path P2. The scanning direction is the direction in which the probe 10 moves when scanning.

In the scanning along the paths P1 and P2, the probe 10 may move in a direction opposite to the overall scanning direction, as shown in the edge inspection process described later. For example, when the outer peripheral surface 42a is scanned along the path P1, a part of the outer peripheral surface 42a may be scanned while the probe 10 moves in the positive Z-axis direction. The extending direction of the scanning path P is not limited to the illustrated example, but may be appropriately set according to the shape, size, or position of the surface to be subjected to the eddy-current flaw detection test in the component 40. For example, the paths P1 and P2 may extend in a direction crossing the Z-axis direction.

The path P1 is a path directed to the region 50b from the region 50a. In scanning along the path P1, the probe 10 scans the region 50a, the edge region 46a, the first region 47, the edge region 46b, and the region 50b in this order. The path P2 is a path directed to the region 50a from the region 50b. In scanning along the path P2, the probe 10 scans the region 50b, the edge region 46b, the first region 47, the edge region 46a, and the region 50a in this order. Thus, each of the paths P1 and P2 extends across the edge 45. That is, the scanning path P is a path that crosses the edge 45 of the component surface 41. The path P1 and the path P2 may be set so as to be separated by a predetermined distance in the direction perpendicular to the Z-axis direction.

The scanning direction is not limited to the illustrated example, and for example, the scanning direction in the paths P1 and P2 may be opposite to that shown in FIG. 5. The scanning direction in the path P1 and the scanning direction in the path P2 may be the same direction.

### {Edge Inspection Process}

Next, the edge inspection process will be described with reference to FIGS. 5 to 8. In the edge inspection process, the presence or absence of defects in the region near the edge of the component surface 41 is inspected. The edge inspection process will be described below with reference to an example of the case where the probe 10 scans along the path P1.

In the example shown in FIG. 5, when the eddy-current detection test on the outer peripheral surface 42a is performed along the path P1, the control unit 23 moves the entire of probe 10 located in the region 50a in the negative Z-axis direction. During this time, the probe 10 detects the change in eddy-current. Here, when crossing the edge 45a, the probe 10 scans the vicinity of a point 51. The point 51 is the intersection of the edge 45a and the path P1. When the vicinity of the point 51 is scanned, an edge signal, which is a signal caused by the edge effect, is detected. The edge effect means that when the vicinity of the edge of the component 40 is scanned in the eddy-current flaw detection test, the flow path of eddy-current generated on the surface of the component 40 changes due to the presence of the edge, and a relatively strong signal indicating the change is detected.

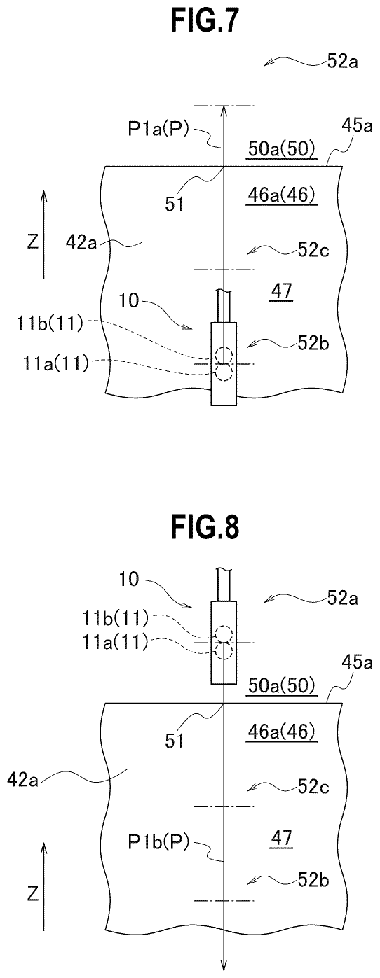

In the edge inspection process, the defect signal in the edge region 46 is detected by the probe 10 scanning the edge region 46 along the first scanning path P1a (see FIG. 7). The first scanning path P1a is a path that is scanned in the first direction from the first region 47 toward the region 50 across the edge region 46. That is, the scanning path P includes the first scanning path P1a. In the example shown in FIG. 7, the positive Z-axis direction corresponds to the first direction. The scanning path P may also include a second scanning path P1b (see FIG. 8), which will be described later.

With reference to FIGS. 6 to 8, the edge inspection process will be described further by taking an example of the case where the edge region 46a is scanned. The edge inspection process may include first, second and third processes.

In the first process illustrated in FIG. 6, as indicated by the arrow A in the figure, the probe 10 disposed at the position 52a in the region 50a moves toward the negative Z-axis direction and scans to an arbitrary position 52b in the first region 47. At this time, the probe 10 scans the edge region 46a so as to cross the edge 45a in the negative Z-axis direction. In such a case, an edge signal is detected from a region on the positive Z-axis direction side of the point 51 to a region on the negative Z-axis direction side of the point 51. Therefore, the signal indicating the change in eddy-current detected in the edge region 46a is affected by the edge signal. Thus, for example, even if a defect exists in the edge region 46a, there is a possibility that the defect signal, which is a signal caused by the defect, is hidden in the edge signal. As described above, in the first process, it may be difficult to detect the defect in the edge region 46a due to the influence of the edge effect. Therefore, the controller 20 may exclude the data related to the signal obtained in the first process from the data related to the signal indicating the change in eddy-current in the outer peripheral surface 42a.

The second process is performed after the first process. In the second process, the probe 10 scans along the first scanning path P1a. In the second process illustrated in FIG. 7, the probe 10 detects the change in eddy-current while moving in the positive Z-axis direction from the position 52b to the position 52a. At this time, the probe 10 may scan at least a part of the first region 47 in the positive Z-axis direction while moving from the position 52b to the position 52c. That is, the probe 10 may detect a first region signal indicating the change in eddy-current in the first region 47. The position 52c may be, for example, the position of the probe 10 when scanning a region around the boundary between the edge region 46a and the first region 47.

Next, the probe 10 detects the change in eddy-current while moving in the positive Z-axis direction from the position 52c to the position 52a. That is, the probe 10 scans in the positive Z-axis direction from the edge region 46a to the region 50a and detects the change in eddy-current in the edge region 46a. At this time, the probe 10 scans along the first scanning path P1a so as to cross the edge region 46a to the edge 45a. In such a case, the edge signal is mainly detected in the region on the positive Z-axis side than the point 51. That is, the signal indicating the change in eddy-current detected when scanning the edge region 46a can be suppressed from being affected by the edge signal. Therefore, for example, even if a defect exists in the edge region 46a, the defect signal caused by the defect is suppressed from being hidden in the edge signal, and the defect signal can be detected more reliably. As described above, in the second process, the probe 10 scans along the first scanning path P1a to detect the change in eddy-current in the edge region 46a. Accordingly, the inspection device 1 can detect the defect existing in the edge region 46a more reliably.

The third process is performed after the second process. In the third process, the probe 10 scans along the second scanning path P1b. The second scanning path P1b is a path scanned in the second direction from the region 50 outside the edge 45 to the first region 47 across the edge 45. In the example shown in FIG. 8, the negative Z-axis direction corresponds to the second direction.

In the third process illustrated in FIG. 8, the probe 10 detects the change in eddy-current while moving in the negative Z-axis direction from the position 52a. At this time, the probe 10 scans the edge region 46a so as to cross the edge 45a in the negative Z-axis direction. Therefore, the controller 20 may exclude data related to a signal detected by the probe 10 when moving from the position 52a to the position 52c from data related to a signal indicating the change in eddy-current in the outer peripheral surface 42a.

After scanning from the position 52a to the position 52c, the probe 10 may scan the first region 47 while moving in the negative Z-axis direction from the position 52c to the position 52b. That is, the probe 10 may scan along the second scanning path P1b and detect a first region signal indicating the change in eddy-current in the first region 47.

By performing such first to third processes, when a defect exists in the edge region 46a, a defect signal caused by the defect can be detected more reliably. Note that the edge inspection process is not limited to the example shown in FIGS. 6 to 8. For example, when scanning by the probe 10 is started from the position 52b, the second and third processes may be performed without performing the first process.

In the eddy-current flaw detection test along the path P1, after the third process, the outer peripheral surface 42a may be scanned by moving the probe 10 from the first region 47 across the edge region 46b to the region 50b (see FIG. 5) outside the edge 45b. At this time, the probe 10 scans in the negative Z-axis direction from the edge region 46b to the region 50b. Therefore, the signal detected in the edge region 46b can be suppressed from being affected by the edge signal due to the edge 45b. Therefore, for example, even if a defect exists in the edge region 46b, the defect signal caused by the defect can be detected more reliably. When the edge region 46b is scanned in the eddy-current flaw detection test along the path P1, the negative Z-axis direction corresponds to the first direction.

As described above, since the inspection process using the inspection device 1 includes the edge inspection process of scanning the edge regions 46a and 46b along the first scanning path P1a, changes in eddy-currents in the edge regions 46a and 46b can be detected more reliably.

In the example shown in FIGS. 6 to 8, the first region signal may be detected by scanning the first region 47 in the positive Z-axis direction (see FIG. 7) and scanning the first region 47 in the negative Z-axis direction (see FIG. 8). That is, the first region signal may include a first signal detected by scanning along the first scanning path P1a and a second signal detected by scanning along the second scanning path P1b. In this case, data related to the first region signal associated with the same sections of the first region 47 are duplicated. Therefore, the determination unit 21 may determine the first region signal corresponding to the region from the first signal and the second signal. Further, the determination unit 21 may determine one of the first and second signals, which has a higher intensity, as the first region signal. In the inspection device 1, the intensity of the signal indicating the change in eddy-current may be detected as a positive or negative voltage (V). For example, the determination unit 21 may determine, as the first region signal, the signal having a larger absolute voltage value out of the first and second signals.

In the inspection process illustrated in FIG. 5, after the eddy-current detection test on the outer peripheral surface 42a along the path P1, the eddy-current detection test on the outer peripheral surface 42a along the path P2 may be performed. At this time, scanning along the path P2 may be performed in the same process as when the eddy-current detection test is performed along the path P1.

In the path P2 illustrated in FIG. 5, the entire of probe 10 located in the region 50b moves in the positive Z-axis direction while scanning the outer peripheral surface 42a. Therefore, the change in eddy-current in the edge region 46b may be detected by scanning the probe 10 in the direction from the first region 47 toward the region 50b across the edge region 46b. In this case, the negative Z-axis direction corresponds to the first direction. The change in eddy-current in the first region 47 may be detected by scanning the probe 10 in the direction from the region 50b toward the first region 47 across the edge region 45b. In this case, the positive Z-axis direction corresponds to the second direction.

The scanning path P is not limited to the paths P1 and P2 shown in FIG. 5. That is, the scanning path P may be appropriately set according to the shape or size of the surface to be subjected to the eddy-current flaw detection test. The scanning path P may include further scanning paths in addition to the paths P1 and P2. For example, after scanning along the paths P1 and P2 is performed, the probe 10 may be moved laterally, and the outer peripheral surface 42a may be scanned in accordance with the same process as scanning along the path P1. After scanning the outer peripheral surface 42a, an eddy-current flaw detection test may be performed on the side surface 43a.

Next, the eddy-current flaw detection device according to the embodiment and the effects of the eddy-current flaw detection method will be described.
(1) The eddy-current flaw detection device 1 according to the embodiment includes: the probe 10 that detects a change in eddy-current in the component surface 41 of the inspection object 40; and the control unit 23 that causes the probe 10 to scan the component surface 41 along the scanning path P crossing the edge 45 of the component surface 41. The scanning path P includes a first scanning path P1a that is scanned in a first direction from the first region 47 of the component surface 41 adjacent to the edge region 46 extending along the edge 45 toward the region 50 outside the edge 45 across the edge region 46. The probe 10 scans along the first scanning path P1a to detect a change in eddy-current in the edge region 46.

In the inspection device 1 according to the embodiment, scanning is performed from the edge region 46 toward the region 50 so as to cross the edge 45 for the detection of a change in eddy-current in the edge region 46. Therefore, a signal indicating the change in eddy-current detected when the edge region 46 is scanned can be suppressed from being affected by an edge effect. Therefore, for example, even if a defect exists in the edge region 46, the defect signal is suppressed from being hidden in the edge signal, and the defect signal can be detected more reliably. Consequently, the inspection device 1 can detect the defect existing in the edge region 46 more reliably. That is, according to the inspection device 1, the eddy-current flaw detection test can be performed more easily.
(2) The scanning path P may include the second scanning path P1b that is scanned in the second direction from the region 50 outside the edge 45 to the first region 47 across the edge 45, and the probe 10 may scan along the second scanning path P1b to detect the first region signal indicating a change in eddy-current in the first region 47.

Thus, for example, after scanning the edge region 46 along the first scanning path P1a, the first region 47 can be scanned along the second scanning path P1b. Therefore, in scanning along the scanning path P, scanning of the edge region 46 and scanning of the first region 47 can be performed. Accordingly, the eddy-current flaw detection test can be performed more easily.
(3) The eddy-current flaw detection device 1 may include the determination unit 21 that determines the first region signal indicating the change in eddy-current in the first region 47. The first region signal may include the first signal detected by scanning along the first scanning path P1a and the second signal detected by scanning along the second scanning path P1b. The determination unit 21 may determine one of the first signal and the second signal, which has a higher intensity, as the first region signal.

Thus, even if data related to the first region signal are obtained in duplicate by scanning along the first scanning path P1a and scanning along the second scanning path P1b, the signal having a higher intensity can be determined as the first region signal. Therefore, the defect signal in the first region 47 can be more reliably detected.
(4) In the eddy-current flaw detection method according to the embodiment, the component surface 41 of the inspection object 40 is scanned by the probe 10 that detects the change in eddy-current in the component surface 41 along the scanning path P that crosses the edge 45 of the component surface 41. In the method, the scanning path P includes a first scanning path P1a that is scanned in the first direction from the first region 47 of the component surface 41 adjacent to the edge region 46 extending along the edge 45 toward the region 50 outside the edge 45 across the edge region 46. In the method, the probe 10 scans along the first scanning path P1a to detect a change of eddy-current in the edge region 46.

In the eddy-current flaw detection method according to the embodiment, scanning is performed from the edge region 46 toward the region 50 so as to cross the edge 45 for the detection of the change in eddy-current in the edge region 46. Therefore, the signal indicating the change in eddy-current detected when the edge region 46 is scanned can be suppressed from being affected by the edge effect. With this reason, for example, even if a defect exists in the edge region 46, the defect signal is suppressed from being hidden in the edge signal, and the defect signal can be detected more reliably. Therefore, the defect existing in the edge region 46 can be detected more reliably. In other words, the eddy-current flaw detection test can be performed more easily.

The present disclosure can contribute to, for example, Goal 9 “Building resilient infrastructure, promoting inclusive and sustainable industrialization, and promoting innovation” of the Sustainable Development Goals (SDGs).

Although some embodiments have been described above, the embodiments can be modified or modified based on the above disclosure. All components of the above embodiments and all features described in the claims may be individually extracted and combined as long as they are consistent with each other.

What is claimed is:

1. An eddy-current flaw detection device comprising:
a probe configured to detect a change in eddy-current in a component surface of an inspection object; and
a control unit configured to cause the probe to scan the component surface along a scanning path that crosses an edge of the component surface; wherein
the scanning path includes a first scanning path that is scanned in a first direction from a first region of the component surface adjacent to an edge region extending along the edge to a region outside the edge across the edge region, and
the probe scans along the first scanning path to detect the change in eddy-current in the edge region.

2. The eddy-current flaw detection device according to claim 1, wherein
the scanning path includes a second scanning path that is scanned in a second direction from the region outside the edge to the first region across the edge, and
the probe scans along the second scanning path to detect the change in eddy-current in the first region.

3. The eddy-current flaw detection device according to claim 2 further comprising:
a determination unit configured to determine a first region signal indicating the change in eddy-current in the first region, wherein
the first region signal includes: a first signal detected by scanning along the first scanning path and a second signal detected by scanning along the second scanning path, and
the determination unit determines one of the first signal and the second signal, which has a higher intensity, as the first region signal.

4. An eddy-current flaw detection method comprising:
scanning a component surface of an inspection object by a probe that detects a change in eddy-current in the component surface along a scanning path that crosses an edge of the component surface; wherein
the scanning path includes a first scanning path that is scanned in the first direction from the first region of the component surface adjacent to the edge region extending along the edge toward the region outside the edge across the edge region; and
the probe scans along the first scanning path to detect the change of eddy-current in the edge region.
